(19) United States
(12) Patent Application Publication
(10) Pub. No.: US 2025/0217640 A1
(43) Pub. Date: Jul. 3, 2025

(54) Training Deep Learning Models based on Characteristics of Accelerators for Improved Energy Efficiency in Accelerating Computations of the Models

(71) Applicant: Micron Technology, Inc., Boise, ID (US)

(72) Inventors: Febin Sunny, Folsom, CA (US); Saideep Tiku, Folsom, CA (US); Shashank Bangalore Lakshman, Folsom, CA (US); Poorna Kale, Folsom, CA (US)

(21) Appl. No.: 18/414,927

(22) Filed: Jan. 17, 2024

Related U.S. Application Data
(60) Provisional application No. 63/485,470, filed on Feb. 16, 2023.

(51) Int. Cl. G06N 3/08

(52) U.S. Cl. CPC G06N 3/08

(57) ABSTRACT

Customization of deep learning models for accelerators of multiplication and accumulation operations. Based on a type of an accelerator to be used to implement the computation of an artificial neural network, a weight matrix of an artificial neural network can be adjusted, during training or via re-training, based on energy consumption characteristics of the type of accelerators. Patterns of weights that can consume more energy in computations implemented via the accelerator can be suppressed via penalizing by a loss function during training, or via pruning and re-training. The adjusted weight matrix can be configured in a computing device having an accelerator of the type. When the computing device performs computations of the artificial neural network using the weight matrix, the accelerator can be used to accelerate multiplication and accumulation operations involving the weight matrix.

### RELATED APPLICATIONS

The present application claims priority to Prov. U.S. Pat. App. Ser. No. 63/485,470 filed Feb. 16, 2023, the entire disclosures of which application are hereby incorporated herein by reference.

### TECHNICAL FIELD

At least some embodiments disclosed herein relate to computations of multiplication and accumulation in general and more particularly, but not limited to, reduction of energy usage in computations of deep learning models.

### BACKGROUND

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates the customization of the training of the weight matrices of artificial neural networks based on the characteristics of accelerators used to accelerate the computations of the artificial neural networks according to one embodiment.

FIG. 2 illustrates the re-training of the weight matrices of artificial neural networks to improve energy efficiency in accelerating the computations of the artificial neural networks according to one embodiment.

FIG. 3 shows energy consumption characteristics of some types of accelerators for customized training of artificial neural networks according to some embodiments.

FIG. 4 shows an analog accelerator implemented using microring resonators according to one embodiment.

FIG. 5 shows another accelerator implemented using microring resonators according to one embodiment.

FIG. 6 shows the computation of a column of weight bits multiplied by a column of input bits to provide an accumulation result according to one embodiment.

FIG. 7 shows the computation of a column of multi-bit weights multiplied by a column of input bits to provide an accumulation result according to one embodiment.

FIG. 8 shows the computation of a column of multi-bit weights multiplied by a column of multi-bit inputs to provide an accumulation result according to one embodiment.

FIG. 9 shows a processing unit configured to perform matrix-matrix operations according to one embodiment.

FIG. 10 shows a processing unit configured to perform matrix-vector operations according to one embodiment.

FIG. 11 shows a processing unit configured to perform vector-vector operations according to one embodiment.

FIG. 12 shows an example computing system with an accelerator according to one embodiment.

FIG. 13 shows a method to train a deep learning model according to one embodiment.

### DETAILED DESCRIPTION

At least some embodiments disclosed herein provide techniques of reducing the energy expenditure in computations of deep learning models that can be accelerated using accelerators for multiplication and accumulation.

Accelerators for multiplication and accumulation can be implemented via different types of technologies, such as microring resonators, synapse memory cells, logic circuits, memristors, etc. As a result, the accelerators can have different energy consumption characteristics. An accelerator of a particular type can consume less energy, and thus advantageous in reduction of energy consumption, in performing computations for inputs having one set of characteristics but not in performing computations for inputs having another set of characteristics. A deep learning model can be customized in training to have characteristics that are advantageous in reducing energy consumption when the computations of the trained deep learning model are accelerated via a particular type of accelerators for multiplication and accumulation.

A typical deep learning technique includes the training of a model of an artificial neural network according to a training dataset. The training operation is configured to adjust the parameters of the artificial neural network, in the form of weight matrices, such that the artificial neural network can produce desirable outputs as indicated in the training dataset in response to inputs as specified in the training dataset.

In at least some embodiments disclosed herein, the training operation is customized to nudge the weight matrices to have characteristics that are more energy efficient for processing via a particular type of accelerators that will be used to accelerate the computations of the model of the artificial neural network.

For example, an accelerator implemented via microring resonators can consume less energy in performing a task than other types of accelerators when the input data of the task has large magnitudes (or can be transformed, e.g., via bitwise left shift, to have large magnitudes). Thus, when a model of an artificial neural network is to be implemented in a computing device having such an accelerator, the back propagation phase of training of the weight matrices of the artificial neural network can be implemented to include a loss function that penalizes small weights. As a result, the trained weight matrices can have a weight distribution having more concentration on large weights than resulting weight matrices trained without the loss function. Thus, the training implemented with the loss function can result in weight matrices that have reduced energy consumption when the computations of multiplication and accumulation involving the weight matrices are accelerated via the accelerator having microring resonators as computing elements.

For example, an accelerator implemented via synapse memory cells can consume less energy in performing a task than other types of accelerators when most bits of the input data of the task have the value of zero (or can be transformed, e.g., via bit inversion, to have mostly zeros). Thus, when a model of an artificial neural network is to be implemented in a computing device having such an accelerator, the back propagation phase of the training of the weight matrices of the artificial neural network can be implemented to include a loss function that penalizes bits of weights having the value of one (or zero when the weights have more zero-bits than one-bits). As a result, the trained weight matrices can have a weight bit distribution having an increased ratio between bits of different values. Thus, the training implemented with the loss function can result in weight matrices that have reduced energy consumption when the computations of multiplication and accumulation involving the weight matrices are accelerated via the accelerator having synapse memory cells as computing elements.

For example, an accelerator implemented via memristors can consume less energy in performing a task than other types of accelerators when the input data of the task has small magnitudes (or can be transformed, e.g., via bitwise right shift, to have small magnitudes). Thus, when a model of an artificial neural network is to be implemented in a computing device having such an accelerator, the back propagation phase of the training of the weight matrices of the artificial neural network can be implemented to include a loss function that penalizes large weights. As a result, the trained weight matrices can have a weight distribution having more concentration on small weights than resulting weight matrices trained without the loss function. Thus, the training implemented with the loss function can result in weight matrices that have reduced energy consumption when the computations of multiplication and accumulation involving the weight matrices are accelerated via the accelerator having memristors as computing elements.

For example, an accelerator implemented via logic circuits can consume an amount of energy substantially independent of the magnitudes of weights in the weight matrices. Thus, when a model of an artificial neural network is to be implemented in a computing device having such an accelerator, the training of the weight matrices of the artificial neural network can be implemented without a loss function for nudging the weights so that the training can achieve improved accuracy.

Optionally, when the model of an artificial neural network trained without a loss function (e.g., trained for an accelerator having logic circuits as computing elements) is to be deploy in a computing device having an accelerator with a different energy consumption characteristic, the originally trained model can be re-trained to implement selective pruning and thus to improve the energy efficiency of the re-trained model implemented in the computing device.

For example, when the accelerator in the computing device is configured with microring resonators as computing elements, the original model trained on a training dataset without a loss function can be re-trained to prune or increase small weights while the differences between the outputs of the original model and the outputs of the re-trained model are minimized in the re-training operation. Thus, the re-trained model can be accelerated in the computing device with a smaller energy expenditure than the original model.

For example, when the accelerator in the computing device is configured with memristors as computing elements, the original model trained on a training dataset without a loss function can be re-trained to prune or reduce large weights while the differences between the outputs of the original model and the outputs of the re-trained model are minimized in the re-training operation. Thus, the re-trained model can be accelerated in the computing device with a smaller energy expenditure than the original model.

For example, when the accelerator in the computing device is configured with memristors as computing elements, the original model trained on a training dataset without a loss function can be re-trained to increase the concentration of one-bits (or zero-bits) while the differences between the outputs of the original model and the outputs of the re-trained model are minimized in the re-training operation. Thus, the re-trained model can be accelerated in the computing device with a smaller energy expenditure than the original model.

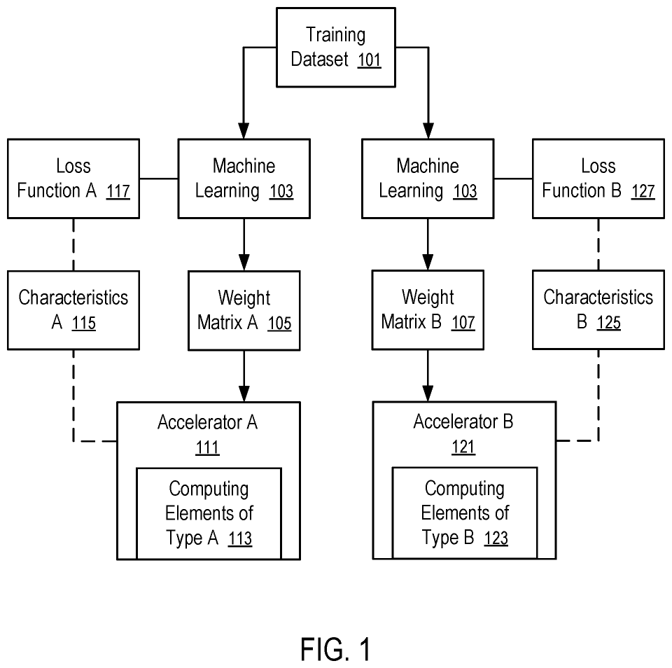

FIG. 1 illustrates the customization of the training of the weight matrices of artificial neural networks based on the characteristics of accelerators used to accelerate the computations of the artificial neural networks according to one embodiment.

In FIG. 1, a training dataset 101 can be used to train a model of an artificial neural network. The artificial neural network can have adjustable parameters configured in a form of weight matrices. A set of inputs to a number of artificial neurons can be combined via a weight matrix to generate weighted inputs to the respective artificial neurons. Each artificial neuron can generate an output in response to a combined input and an activation function; and the outputs of the artificial neurons can be connected as inputs to further artificial neurons.

A technique of machine learning 103 can be used to adjust the weight matrix of the artificial neural network to generate outputs in a way similar to the training dataset 101. For example, the training dataset 101 can include inputs and outputs responsive to the inputs. The machine learning 103 can adjust the weight matrix of the artificial neural network to minimize the differences between the outputs specified in the training dataset 101 for inputs and the corresponding outputs generated by the artificial neural network having the trained weight matrix.

In FIG. 1, the technique of machine learning 103 is further augmented with a loss function (e.g., 117 or 127) to customize the trained weight matrix (e.g., 105 or 107) for an accelerator (e.g., 111 or 121) used to accelerate the computations of multiplication and accumulation according to the weight matrix (e.g., 105 or 107) for improved energy efficiency.

For example, the accelerator 111 has computation elements of type 113. As a result, the accelerator 111 has characteristics 115 indicative of a pattern of energy consumption in perform computations using the weight matrix 105. A loss function 117 in the back propagation phase of the machine learning 103 can be configured according to the characteristics 115 to suppress one or more patterns of weights in the weight matrix 105 in favor of one or more alternative patterns of weights such that the computations performed by the accelerator 111 according to the trained weight matrix 105 is reduced or minimized.

For example, machine learning 103 adjusts the weight matrix 105 to reduce or minimize not only the differences in the outputs produced via the weight matrix 105 and outputs in the training dataset 101 but also the loss function 117.

Similarly, the accelerator 121 has computation elements of type 123. As a result, the accelerator 121 has characteristics 125 indicative of a pattern of energy consumption in perform computations using the weight matrix 107. A loss function 127 in the back propagation phase of the machine learning 103 can be configured according to the characteristics 125 to suppress one or more patterns of weights in the weight matrix 107 in favor of one or more alternative patterns of weights such that the computations performed by the accelerator 121 according to the trained weight matrix 107 is reduced or minimized. The machine learning 103 adjusts the weight matrix 107 to reduce or minimize not only the differences in the outputs produced via the weight matrix 107 and outputs in the training dataset 101 but also the loss function 127.

For example, the pattern of energy consumption of the accelerator 111 can be consuming more energy for operating on weights of smaller magnitudes than for operating on weights of larger magnitudes (e.g., as in accelerators having microring resonators as computing elements). Thus, the loss function 117 can be constructed to penalize small weights to promote large weights in the weight matrix 105.

For example, the pattern of energy consumption of the accelerator 121 can be consuming more energy for operating on weights of larger magnitudes than for operating on weights of smaller magnitudes (e.g., as in accelerators having memristors as computing elements). Thus, the loss function 127 can be constructed to penalize large weights and thus promote small weights in the weight matrix 107.

For example, the pattern of energy consumption of the accelerator 111 can be consuming more energy for operating on weights of larger magnitudes than for operating on weights of smaller magnitudes (e.g., as in accelerators having memristors as computing elements). Thus, the loss function 117 can be constructed to penalize large weights and thus promote small weights in the weight matrix 105.

For example, the pattern of energy consumption of the accelerator 111 can be consuming more energy for operating on weights with more bits having the value of one (one-bits) than weights with less one-bits (e.g., as in accelerators having synapse memory cells as computing elements). Thus, the loss function 117 can be constructed to penalize one-bits and thus zero-bits in the weight matrix 105. In some cases where the weight matrix 105 has more zero-bits (e.g., bits of weights having the value of zero) than one-bits, the loss function 117 can be configured to penalize one-bits and thus promote zero-bits; and the accelerator 111 can be used to operate on a bitwise inverted version of the weight matrix 105 in performing the computation of the artificial neural network.

In FIG. 1, an artificial neural network is trained using machine learning 103 based on not only the training dataset 101 that specifies the samples of input to output relations, but also the loss function (e.g., 117, 127). The loss functions (e.g., 117, 127) are configured to be representative of the selection of weight patterns according to energy usage characteristics (e.g., 115, 125) of the accelerator (e.g., 111, 121). Thus, when the accelerator (e.g., 111, 121) is used to accelerate the computations of multiplication and accumulation involved in the use of the weight matrices (e.g., 105, 107) of the artificial neural network, the energy consumption for the computations is reduced.

When the energy consumption of an accelerator is substantially independent on patterns of weights in the weight matrix (e.g., an accelerator having logic circuits as computing elements), the machine learning 103 can be applied without such a loss function (e.g., 117 or 127) that is configured to nudge the patterns of weights in the trained weight matrix (e.g., 105 or 107).

In general, the use of such a loss function (e.g., 117 or 127) can reduce the accuracy of the trained weight matrix (e.g., 105 or 107). However, the reduced energy expenditure can be beneficial at the cost of a limited reduction in accuracy. The use of the loss function 117 can be configured to balance the reduction in energy expenditure and the reduction in accuracy. For example, cost weights can be applied to the output of the loss function 127 and the differences in the outputs produced via the trained weight matrix (e.g., 105, 107) and outputs in the training dataset 101 to evaluate a combined cost. The cost weights can be adjusted to balance the accuracy goal relative to the energy reduction goal.

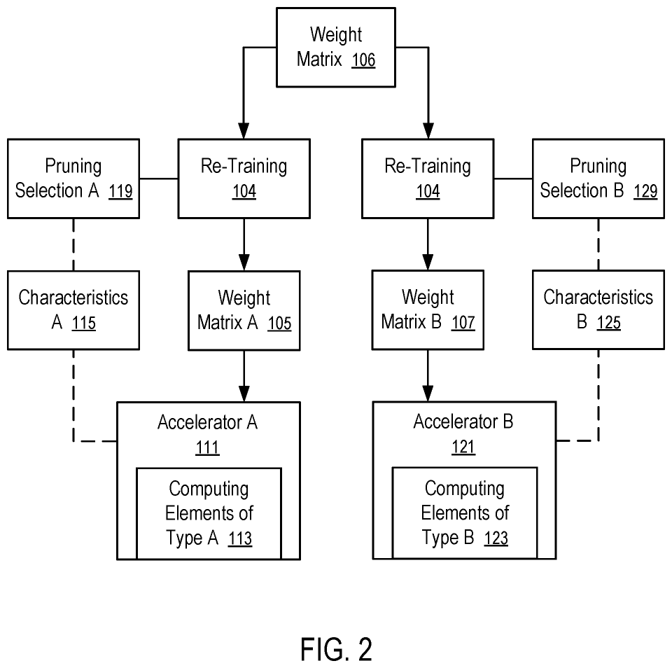

Optionally, a weight matrix obtained without the use of a loss function (e.g., 117 or 127) (e.g., suitable for an accelerator having logic circuits as computing elements) is pruned, customized, and re-trained to generate a customized weight matrix for an accelerator having a preference for a pattern of weights for reduced energy consumption, as in FIG. 2

FIG. 2 illustrates the re-training of the weight matrices of artificial neural networks to improve energy efficiency in accelerating the computations of the artificial neural networks according to one embodiment.

In FIG. 2, a weight matrix 106 (e.g., trained for an accelerator having logic circuits as computing elements) can be customized for accelerators (e.g., 111, 121) having different energy usage characteristics (e.g., 115 and 125). The energy usage characteristics (e.g., 115 and 125) can be used to prune or adjust the weight matrix 106; and the re-training 104 can be used to minimize the output differences of the original weight matrix 106 and the customized weight matrices (e.g., 105 and 107).

For example, a pruning selection (e.g., 119 or 129) can be used to identify a set of weights in the weight matrix 106 and modify the selected weights to nudge the patter of weights in the weight matrix 106. The re-training 104 can adjust the remaining weights to best match the outputs of the original weight matrix 106 and the outputs of the re-trained weight matrix (e.g., 105 or 107). Optionally, the selection and modification in the pruning selection (e.g., 119 or 129) can be adjusted to balance a combined cost goal in accuracy and energy reduction in generating the re-trained weight matrix (e.g., 105 or 107).

For example, after the re-training 104, the energy performance of the trained weight matrix (e.g., 105 or 107) can be evaluated. Further, the accuracy performance of the trained weight matrix (e.g., 105 or 107) is also evaluated. A combined performance indicator can be a weighted average of the energy performance and the accuracy performance. The weight selection and modification operations in the pruning selection (e.g., 119 or 129) can be adjusted to search for a selection and modification solution that improves or optimizes the combined performance indicator.

For example, the accelerator 121 can have the characteristics of consuming more energy for operating on weights of smaller magnitudes than for operating on weights of larger magnitudes (e.g., as in accelerators having microring resonators as computing elements). To generate the customized weight matrix 107 for the accelerator 121, the pruning selection 129 can be configured to remove or increase weights of small magnitudes to promote large weights in the customized weight matrix 107 with limited reduction in accuracy.

For example, the accelerator 121 can have the characteristics of consuming more energy for operating on weights of large magnitudes than for operating on weights of smaller magnitudes (e.g., as in accelerators having memristors as computing elements). To generate the customized weight matrix 107 for the accelerator 121, the pruning selection 129 can be configured to remove or decrease weights of large magnitudes to promote small weights in the customized weight matrix 107 with limited reduction in accuracy.

For example, the accelerator 121 can have the characteristics of consuming more energy for operating on weights having more one-bits than weights having less one-bits (e.g., as in accelerators having memristors as computing elements). To generate the customized weight matrix 107 for the accelerator 121, the pruning selection 129 can be configured to selectively invert one-bits of the weight matrix 106 to promote zero-bits in the customized weight matrix 107 with limited reduction in accuracy.

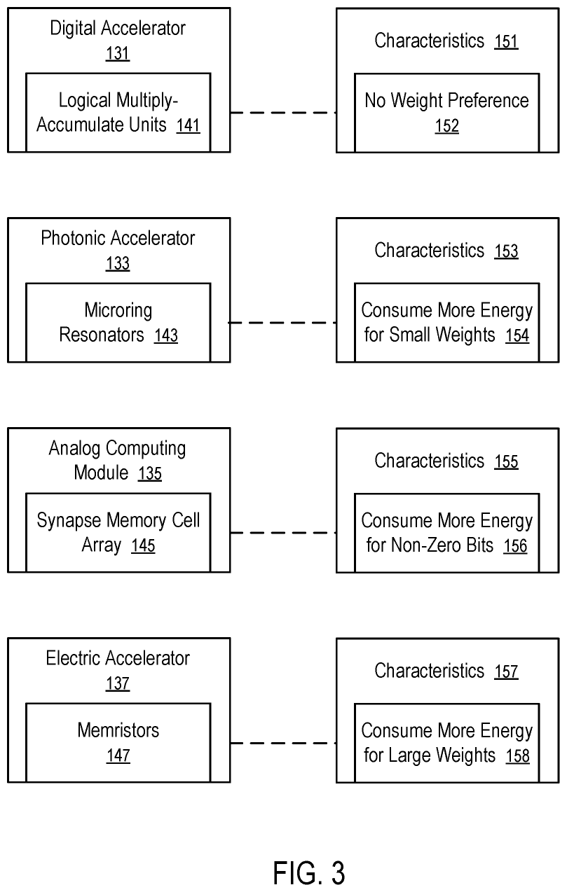

FIG. 3 shows energy consumption characteristics of some types of accelerators for customized training of artificial neural networks according to some embodiments. The characteristics can be used to customize the training or re-training of deep learning models as in FIG. 1 and FIG. 2

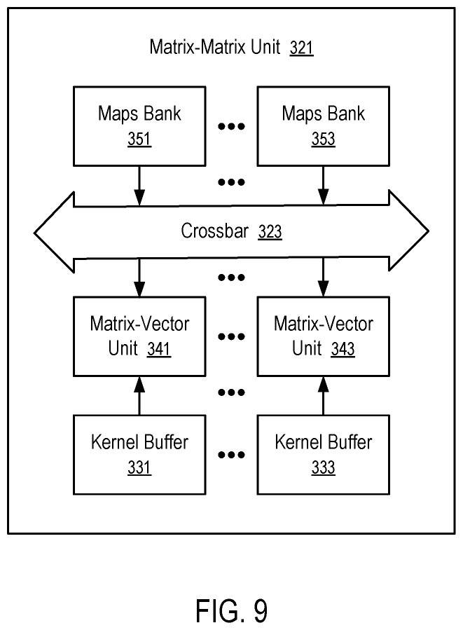

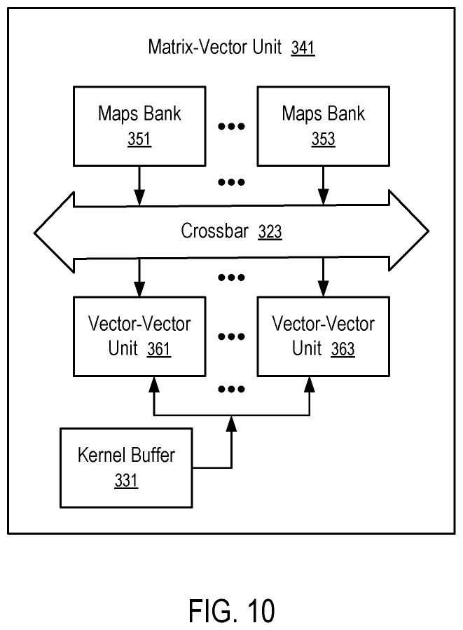

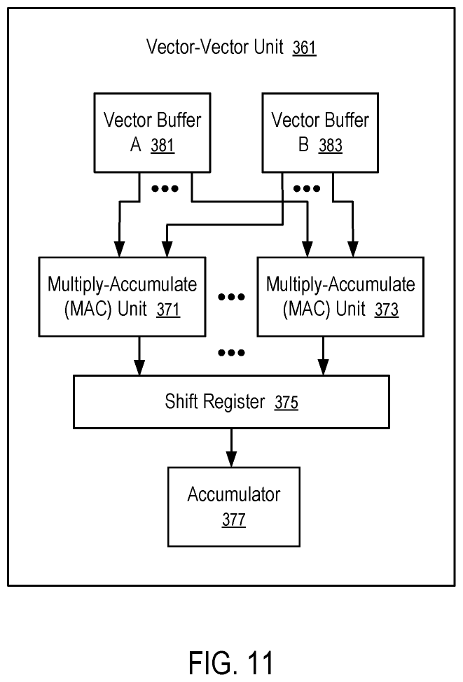

A digital accelerator 131 can be implemented using logical multiply-accumulate units 141. For example, such a digital accelerator 131 can have matrix-matrix units 321 configured as in FIG. 9, matrix-vector units 341 configured as in FIG. 10, vector-vector units 361 configured as in FIG. 11, and multiply-accumulate units 371, . . . , 373 implemented using logical circuits. Such a digital accelerator 131 can have the energy consumption characteristics 151 of having no weight preferences 152. Thus, a training dataset 101 can be trained via machine learning 103 without using a loss function to generate an original weight matrix 106 having a high accuracy level.

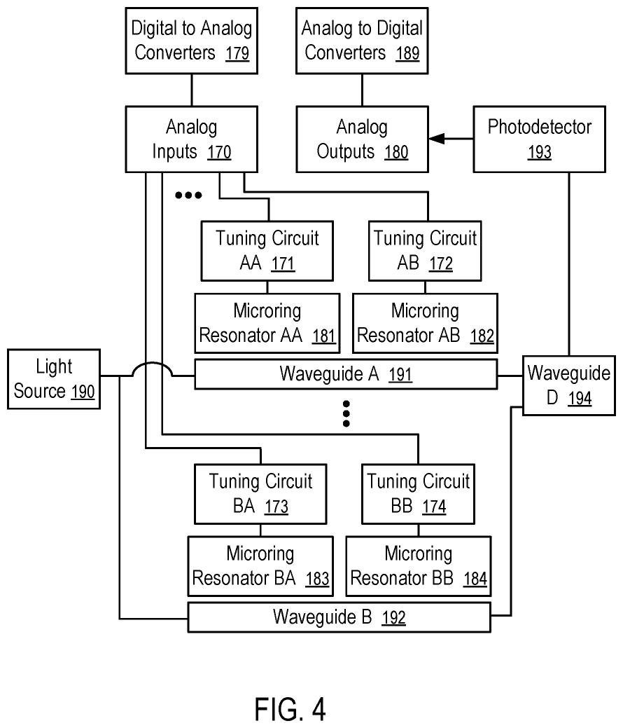

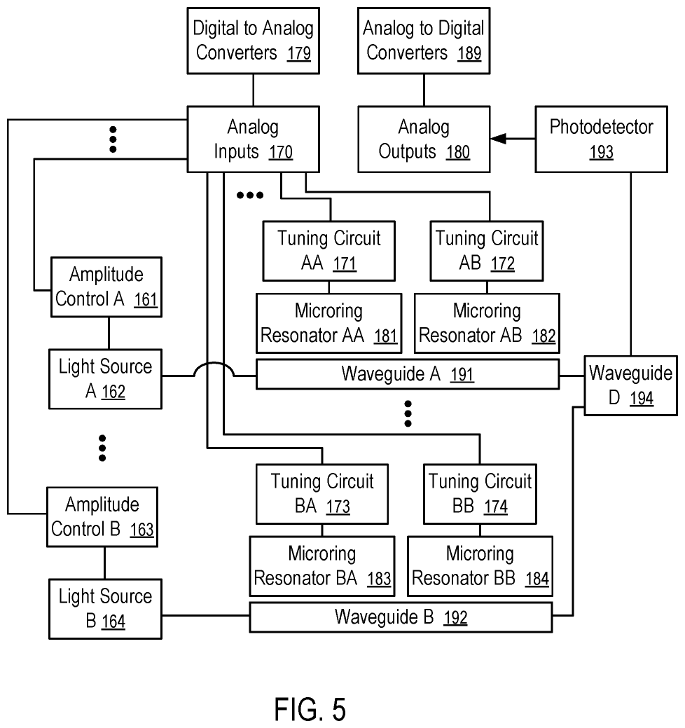

A photonic accelerator 133 can be implemented using microring resonators 143, as in FIG. 4 and FIG. 5. Such a photonic accelerator 133 can have the energy consumption characteristics 153 of consuming more energy for small weights 154. Thus, a training dataset 101 can be trained via machine learning 103 with a loss function (e.g., 117 or 127) configured according to the characteristics 153 to suppress small weights and promote large weights. Alternatively, an original weight matrix 106 having a high accuracy level can be re-trained 104 using a pruning selection (e.g., 119 or 129) configured according to the characteristics 153 to suppress small weights and promote large weights.

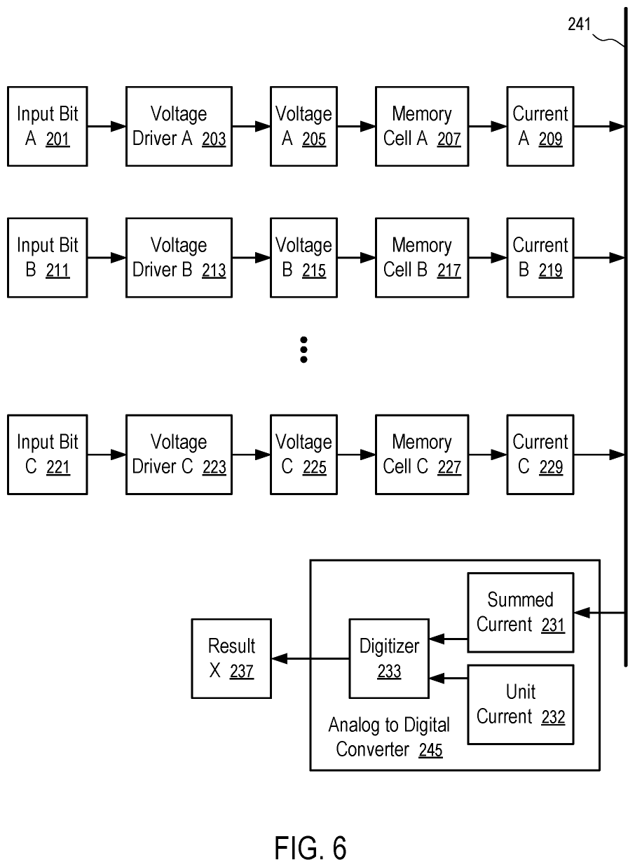

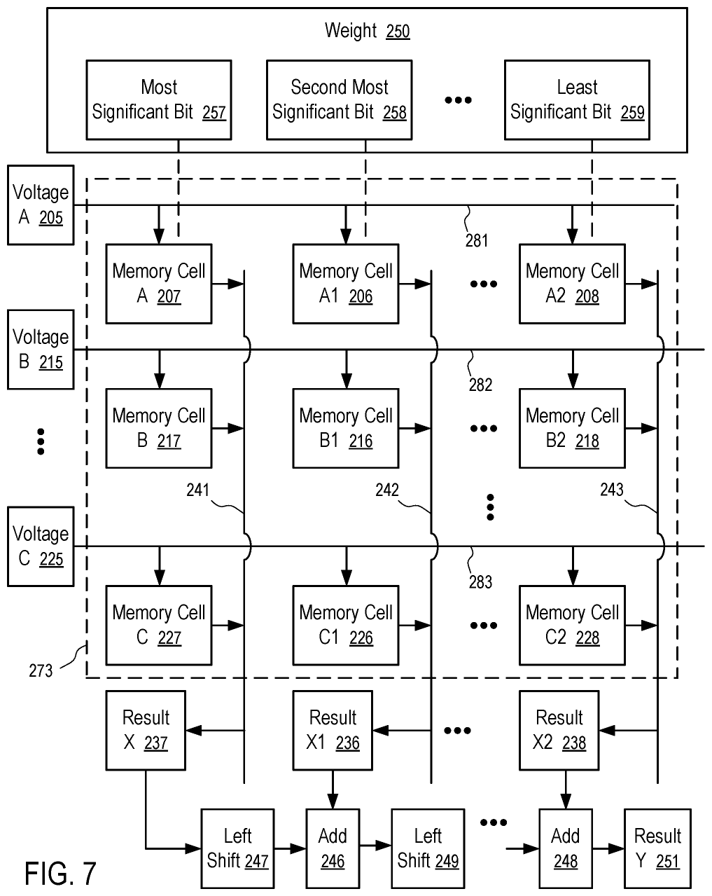

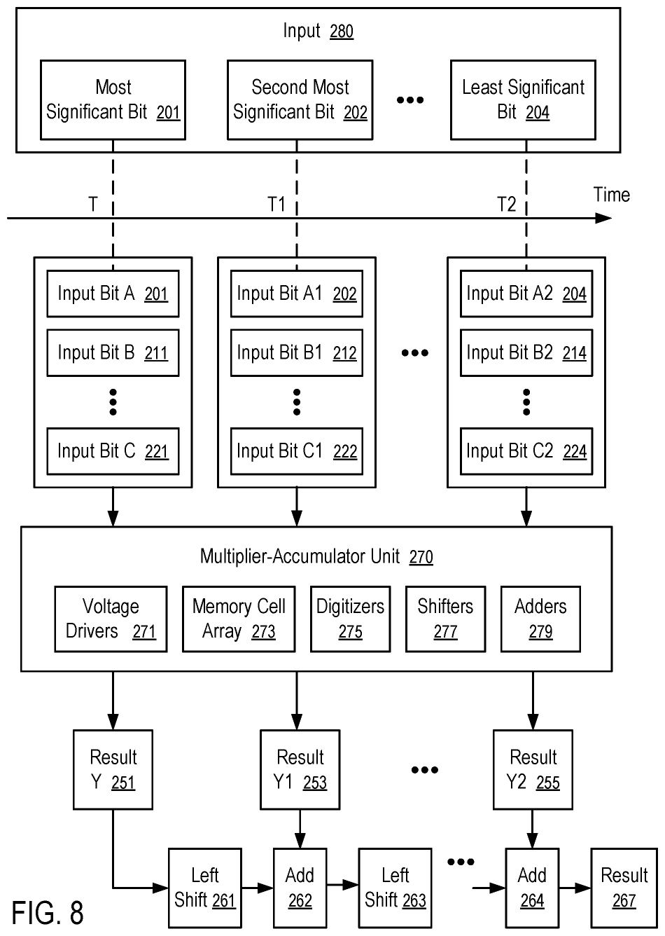

An analog computing module 135 can use a synapse memory cell array 145 to accelerate operations of multiplication and accumulation, as in FIG. 6, FIG. 7, and FIG. 8. Such an analog computing module 135 can have the energy consumption characteristics 155 of consuming more energy for non-zero bits 156. Thus, a training dataset 101 can be trained via machine learning 103 with a loss function (e.g., 117 or 127) configured according to the characteristics 155 to suppress non-zero bits (or suppress zero-bits and use the inverted matrix in computation). Alternatively, an original weight matrix 106 having a high accuracy level can be re-trained 104 using a pruning selection (e.g., 119 or 129) configured according to the characteristics 155 to increase the concentration of zero-bits (or one-bits) in the re-trained weight matrix (e.g., 105 or 107).

An electric accelerator 137 can use memristors 147 to perform the operations of multiplications. Such an electric accelerator 137 can have the energy consumption characteristics 157 of consuming more energy for large weights 158. Thus, a training dataset 101 can be trained via machine learning 103 with a loss function (e.g., 117 or 127) configured according to the characteristics 157 to suppress large weights and promote small weights. Alternatively, an original weight matrix 106 having a high accuracy level can be re-trained 104 using a pruning selection (e.g., 119 or 129) configured according to the characteristics 157 to suppress large weights and promote small weights.

FIG. 4 shows an analog accelerator implemented using microring resonators according to one embodiment. For example, the photonic accelerator 133 of FIG. 3 can be implemented in a way as in FIG. 4.

In FIG. 4, digital to analog converters 179 can convert digital inputs (e.g., weight matrix 106, 105 or 107) into corresponding analog inputs 170; and analog outputs 180 can be converted to digital forms via analog to digital converters 189.

The analog accelerator of FIG. 4 has microring resonators 181, 182, . . . , 183, and 184, and a light source 190 (e.g., a semiconductor laser diode, such as a vertical-cavity surface-emitting laser (VCSEL)) configured to feed light inputs into waveguides 191, . . . , 192.

Each of the waveguides (e.g., 191 or 192) is configured with multiple microring resonators (e.g., 181, 182; or 183, 184) to change the magnitude of the light going through the respective waveguide (e.g., 191 or 192).

A tuning circuit (e.g., 171, 172, 173, or 174) of a microring resonator (e.g., 181, 182, 183, or 184) can change resonance characteristics of the microring resonator (e.g., 181, 182, 183, or 184) through heat or carrier injection.

Thus, the ratio between the magnitude of the light coming out of the waveguide (e.g., 191) to enter a combining waveguide 194 and the magnitude of the light going into the waveguide (e.g., 191) near the light source 190 is representative of the multiplications of attenuation factors implemented via tuning circuits (e.g., 171 and 172) of microring resonators (e.g., 181 and 182) in electromagnetic interaction with the waveguide (e.g., 191).

The combining waveguide 194 sums the results of the multiplications performed via the lights going through the waveguides 191, . . . , 192. A photodetector 193 is configured to convert the combined optical outputs from the waveguide into analog outputs 180 in electrical domain.

For example, a set of inputs from the input weight matrix (e.g., 106, 105, or 107) can be applied as a portion of analog inputs 170 to the tuning circuits 171, . . . , 173; and a set of weight elements from a row of the weight matrix (e.g., 106, 105, or 107) can be applied via another portion of analog inputs 170 to the tuning circuits 172, . . . , 174; and the output of the combining waveguide 194 to the photodetector 193 represents the multiplication and accumulation between the set of inputs weight via the set of weight elements. Analog to digital converters 189 can convert the analog outputs 180 into an output.

The same set of input elements as applied via the tuning circuits 171, . . . , 173 can be maintained while a set of weight elements from a next row of the weight matrix (e.g., 106, 105, or 107) can be applied via a portion of analog inputs 170 to the tuning circuits 172, . . . , 174 to perform the multiplication and accumulation of weights of the next row to the input elements. After completion of the computations involving the same set of input elements, a next set of input elements can be loaded from the input matrix.

Alternatively, a same set of weight elements from a row of the weight matrix (e.g., 106, 105, or 107) can be maintained (e.g., via a portion of analog inputs 170 to the tuning circuits 172, . . . , 174) for different sets of input elements. After completion of the computations involving the same set of weight elements, a next set of weight elements can be loaded from the weight matrix.

Alternatively, inputs can be applied via the tuning circuits 172, . . . , 174; and weight elements can be applied via the tuning circuits 171, . . . , 173.

FIG. 5 shows another accelerator implemented using microring resonators according to one embodiment. For example, the photonic accelerator 133 of FIG. 3 can be implemented in a way as in FIG. 5.

Similar to the analog accelerator of FIG. 4, the analog accelerator of FIG. 5 has microring resonators 181, 182, . . . , 183, and 184 with tuning circuits 171, 172, . . . , 173, and 174, waveguides 191, . . . , and 192, and a combining waveguide 194.

In FIG. 5, the analog accelerator has amplitude controls 161, . . . , and 163 for light sources 162, . . . , 164 connected to the waveguides 191, . . . , and 192 respectively. Thus, the amplitudes of the lights going into the waveguides 191, . . . , and 192 are controllable via a portion of analog inputs 170 connected to the amplitude controls 161, . . . 163. The amplitude of the light coming out of a waveguide (e.g., 191) is representative of the multiplications of the input to the amplitude control (e.g., 161) of the light source (e.g., 162) of the waveguide (e.g., 191) and the inputs to the tuning circuits (e.g., 171 and 172) of microring resonators (e.g., 181 and 182) interacting with the waveguide (e.g., 191).

For example, inputs from the input weight matrix (e.g., 106, 105, or 107) can be applied via the amplitude controls 161, . . . , 163; weight elements from the weight matrix (e.g., 106, 105, or 107) can be applied via the tuning circuits 171, . . . , 173 (or 172, . . . , 174); and an optional scaling factor can also be applied via the tuning circuits 172, . . . , 174 (or 171, . . . , 173).

Alternatively, inputs from the input weight matrix (e.g., 106, 105, or 107) can be applied via the tuning circuits 171, . . . , 173 (or 172, . . . , 174); and weight elements from the weight matrix (e.g., 106, 105, or 107) can be applied via the amplitude controls 161, . . . , 163.

Optionally, microring resonators 182, . . . , 184 and their tuning circuits 172, . . . , 174 can be omitted. A scaling factor can be applied by an accelerator manager.

FIG. 6 shows the computation of a column of weight bits multiplied by a column of input bits to provide an accumulation result according to one embodiment. For example, the synapse memory cell array 145 in an analog computing module 135 of FIG. 3 can be configured in a way as illustrated in FIG. 6 to perform operations of multiplication and accumulation.

In FIG. 6, a column of synapse memory cells 207, 217, . . . , 227 (e.g., in the memory cell array 145 of an analog computing module 135) can be programmed in the synapse mode to have threshold voltages at levels representative of weights stored one bit per memory cell.

The column of memory cells 207, 217, . . . , 227, programmed in the synapse mode, can be read in a synapse mode, during which voltage drivers 203, 213, . . . , 223 are configured to apply voltages 205, 215, . . . , 225 concurrently to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 (e.g., bitline) for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 6, the voltages 205, 215, . . . , 225 applied to the memory cells 207, 217, . . . 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 6 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 6 to perform multiplication and accumulation operations.

The circuit illustrated in FIG. 6 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 6.

The circuit illustrated in FIG. 6 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 6 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 7 shows the computation of a column of multi-bit weights multiplied by a column of input bits to provide an accumulation result according to one embodiment.

In FIG. 7, a weight 250 in a binary form has a most significant bit 257, a second most significant bit 258, . . . , a least significant bit 259. The significant bits 257, 258, . . . , 259 can be stored in a row of memory cells 207, 206, . . . , 208 (e.g., in the memory cell array 145 of an analog computing module 135) across a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 6).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 6); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 6).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 6, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 8.

The circuit illustrated in FIG. 7 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 7 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 8 shows the computation of a column of multi-bit weights multiplied by a column of multi-bit inputs to provide an accumulation result according to one embodiment.

In FIG. 8, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 7. The multiplier-accumulator unit 270 has voltage drivers 271 connected to apply voltages 205, 215, . . . , 225 representative of the input bits 201, 211, . . . 221. The multiplier-accumulator unit 270 has a memory cell array 273 storing bits of weights as in FIG. 7. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 7. In some implementations, the logic circuits of the multiplier-accumulator unit 270 (e.g., shifters 277 and adders 279) are implemented as part of the inference logic circuit of the analog computing module 135.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280). The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The analog computing module 135 of FIG. 3 can be configured to perform operations of multiplication and accumulation in a way as illustrated in FIG. 6, FIG. 7, and FIG. 8.

FIG. 9 shows a processing unit 321 configured to perform matrix-matrix operations according to one embodiment. For example, the logical multiply-accumulate units 141 of the digital accelerator 131 of FIG. 3 can be configured as the matrix-matrix unit 321 of FIG. 9.

In FIG. 9, the matrix-matrix unit 321 includes multiple kernel buffers 331 to 333 and multiple maps banks 351 to 353. Each of the maps banks 351 to 353 stores one vector of a matrix operand that has multiple vectors stored in the maps banks 351 to 353 respectively; and each of the kernel buffers 331 to 333 stores one vector of another matrix operand that has multiple vectors stored in the kernel buffers 331 to 333 respectively. The matrix-matrix unit 321 is configured to perform multiplication and accumulation operations on the elements of the two matrix operands, using multiple matrix-vector units 341 to 343 that operate in parallel.

A crossbar 323 connects the maps banks 351 to 353 to the matrix-vector units 341 to 343. The same matrix operand stored in the maps bank 351 to 353 is provided via the crossbar 323 to each of the matrix-vector units 341 to 343; and the matrix-vector units 341 to 343 receives data elements from the maps banks 351 to 353 in parallel. Each of the kernel buffers 331 to 333 is connected to a respective one in the matrix-vector units 341 to 343 and provides a vector operand to the respective matrix-vector unit. The matrix-vector units 341 to 343 operate concurrently to compute the operation of the same matrix operand, stored in the maps banks 351 to 353 multiplied by the corresponding vectors stored in the kernel buffers 331 to 333. For example, the matrix-vector unit 341 performs the multiplication operation on the matrix operand stored in the maps banks 351 to 353 and the vector operand stored in the kernel buffer 331, while the matrix-vector unit 343 is concurrently performing the multiplication operation on the matrix operand stored in the maps banks 351 to 353 and the vector operand stored in the kernel buffer 333.

Each of the matrix-vector units 341 to 343 in FIG. 9 can be implemented in a way as illustrated in FIG. 10.

FIG. 10 shows a processing unit 341 configured to perform matrix-vector operations according to one embodiment. For example, the matrix-vector unit 341 of FIG. 10 can be used as any of the matrix-vector units in the matrix-matrix unit 321 of FIG. 9.

In FIG. 10, each of the maps banks 351 to 353 stores one vector of a matrix operand that has multiple vectors stored in the maps banks 351 to 353 respectively, in a way similar to the maps banks 351 to 353 of FIG. 9. The crossbar 323 in FIG. 10 provides the vectors from the maps banks 351 to the vector-vector units 361 to 363 respectively. A same vector stored in the kernel buffer 331 is provided to the vector-vector units 361 to 363.

The vector-vector units 361 to 363 operate concurrently to compute the operation of the corresponding vector operands, stored in the maps banks 351 to 353 respectively, multiplied by the same vector operand that is stored in the kernel buffer 331. For example, the vector-vector unit 361 performs the multiplication operation on the vector operand stored in the maps bank 351 and the vector operand stored in the kernel buffer 331, while the vector-vector unit 363 is concurrently performing the multiplication operation on the vector operand stored in the maps bank 353 and the vector operand stored in the kernel buffer 331.

When the matrix-vector unit 341 of FIG. 10 is implemented in a matrix-matrix unit 321 of FIG. 9, the matrix-vector unit 341 can use the maps banks 351 to 353, the crossbar 323 and the kernel buffer 331 of the matrix-matrix unit 321.

Each of the vector-vector units 361 to 363 in FIG. 10 can be implemented in a way as illustrated in FIG. 11.

FIG. 11 shows a processing unit 361 configured to perform vector-vector operations according to one embodiment. For example, the vector-vector unit 361 of FIG. 11 can be used as any of the vector-vector units in the matrix-vector unit 341 of FIG. 10.

In FIG. 11, the vector-vector unit 361 has multiple multiply-accumulate (MAC) units 371 to 373. Each of the multiply-accumulate (MAC) units 371 to 373 can receive two numbers as operands, perform multiplication of the two numbers, and add the result of the multiplication to a sum maintained in the multiply-accumulate (MAC) unit.

Each of the vector buffers 381 and 383 stores a list of numbers. A pair of numbers, each from one of the vector buffers 381 and 383, can be provided to each of the multiply-accumulate (MAC) units 371 to 373 as input. The multiply-accumulate (MAC) units 371 to 373 can receive multiple pairs of numbers from the vector buffers 381 and 383 in parallel and perform the multiply-accumulate (MAC) operations in parallel. The outputs from the multiply-accumulate (MAC) units 371 to 373 are stored into the shift register 375; and an accumulator 377 computes the sum of the results in the shift register 375.

When the vector-vector unit 361 of FIG. 11 is implemented in a matrix-vector unit 341 of FIG. 10, the vector-vector unit 361 can use a maps bank (e.g., 351 or 353) as one vector buffer 381, and the kernel buffer 331 of the matrix-vector unit 341 as another vector buffer 383.

The vector buffers 381 and 383 can have a same length to store the same number/count of data elements. The length can be equal to, or the multiple of, the count of multiply-accumulate (MAC) units 371 to 373 in the vector-vector unit 361. When the length of the vector buffers 381 and 383 is the multiple of the count of multiply-accumulate (MAC) units 371 to 373, a number of pairs of inputs, equal to the count of the multiply-accumulate (MAC) units 371 to 373, can be provided from the vector buffers 381 and 383 as inputs to the multiply-accumulate (MAC) units 371 to 373 in each iteration; and the vector buffers 381 and 383 feed their elements into the multiply-accumulate (MAC) units 371 to 373 through multiple iterations.

In one embodiment, the communication bandwidth of the bus between the digital accelerator 131 and the memory is sufficient for the matrix-matrix unit 321 to use portions of the memory as the maps banks 351 to 353 and the kernel buffers 331 to 333.

In another embodiment, the maps banks 351 to 353 and the kernel buffers 331 to 333 are implemented in a portion of the local memory of the digital accelerator 131. The communication bandwidth of the bus 111 between the digital accelerator 131 and the memory sufficient to load, into another portion of the local memory, matrix operands of the next operation cycle of the matrix-matrix unit 321, while the matrix-matrix unit 321 is performing the computation in the current operation cycle using the maps banks 351 to 353 and the kernel buffers 331 to 333 implemented in a different portion of the local memory of the digital accelerator 131.

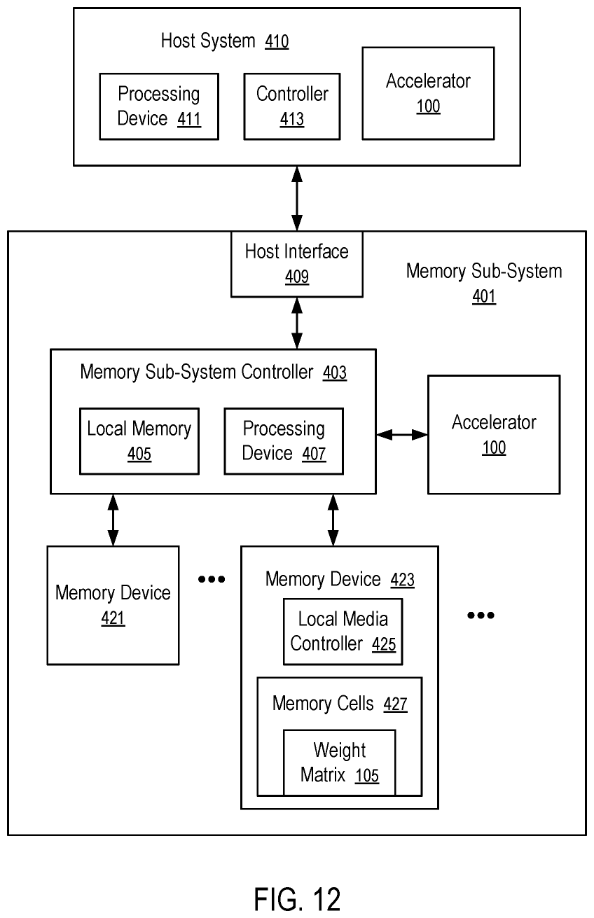

FIG. 12 shows an example computing system with an accelerator according to one embodiment.

The example computing system of FIG. 12 includes a host system 410 and a memory sub-system 401. An accelerator 100 can be configured in the memory sub-system 401, or in the host system 410, or both. The accelerator 100 can include a digital accelerator 131, a photonic accelerator 133, an analog computing module 135, an electric accelerator 137, or an accelerator of another type. In some implementations, a portion of the accelerator 100 is implemented in the memory sub-system 401, and another portion of the accelerator 100 is implemented in the host system 410.

For example, the machine learning 103 of FIG. 1 or the re-training 104 of FIG. 2 can be performed in the computing system of FIG. 12. The accelerator 100 can be used to accelerate the multiplication and accumulation operations performed during the machine learning 103 or the re-training 104.

For example, a deep learning model can be customized using the techniques of FIG. 1 or FIG. 2 for execution in the computing system of FIG. 12. For example, the machine learning 103 of FIG. 1 or the re-training 104 of FIG. 2 can be customized based on the energy consumption characteristics of the accelerator 100 for reduced energy consumption with limited degradation in accuracy.

The memory sub-system 401 can include media, such as one or more volatile memory devices (e.g., memory device 421), one or more non-volatile memory devices (e.g., memory device 423), or a combination of such.

A memory sub-system 401 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system can include a host system 410 that is coupled to one or more memory sub-systems 401. FIG. 12 illustrates one example of a host system 410 coupled to one memory sub-system 401. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 410 can include a processor chipset (e.g., processing device 411) and a software stack executed by the processor chipset. The processor chipset can include one or more cores, one or more caches, a memory controller (e.g., controller 413) (e.g., NVDIMM controller), and a storage protocol controller (e.g., PCIe controller, SATA controller). The host system 410 uses the memory sub-system 401, for example, to write data to the memory sub-system 401 and read data from the memory sub-system 401.

The host system 410 can be coupled to the memory sub-system 401 via a physical host interface 409. Examples of a physical host interface 409 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, or any other interface. The physical host interface 409 can be used to transmit data between the host system 410 and the memory sub-system 401. The host system 410 can further utilize an NVM express (NVMe) interface to access components (e.g., memory devices 423) when the memory sub-system 401 is coupled with the host system 410 by the PCIe interface. The physical host interface 409 can provide an interface for passing control, address, data, and other signals between the memory sub-system 401 and the host system 410. FIG. 12 illustrates a memory sub-system 401 as an example. In general, the host system 410 can access multiple memory sub-systems via a same communication connection, multiple separate communication connections, and/or a combination of communication connections.

The processing device 411 of the host system 410 can be, for example, a microprocessor, a central processing unit (CPU), a processing core of a processor, an execution unit, etc. In some instances, the controller 413 can be referred to as a memory controller, a memory management unit, and/or an initiator. In one example, the controller 413 controls the communications over a bus coupled between the host system 410 and the memory sub-system 401. In general, the controller 413 can send commands or requests to the memory sub-system 401 for desired access to memory devices 423, 421. The controller 413 can further include interface circuitry to communicate with the memory sub-system 401. The interface circuitry can convert responses received from the memory sub-system 401 into information for the host system 410.

The controller 413 of the host system 410 can communicate with the controller 403 of the memory sub-system 401 to perform operations such as reading data, writing data, or erasing data at the memory devices 423, 421 and other such operations. In some instances, the controller 413 is integrated within the same package of the processing device 411. In other instances, the controller 413 is separate from the package of the processing device 411. The controller 413 and/or the processing device 411 can include hardware such as one or more integrated circuits (ICs) and/or discrete components, a buffer memory, a cache memory, or a combination thereof. The controller 413 and/or the processing device 411 can be a microcontroller, special purpose logic circuitry (e.g., a field programmable gate array (FPGA), an application specific integrated circuit (ASIC), etc.), or another suitable processor.

The memory devices 423, 421 can include any combination of the different types of non-volatile memory components and/or volatile memory components. The volatile memory devices (e.g., memory device 421) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 423 can include one or more arrays of memory cells 427. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 423 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 423 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 423 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 403 (or controller 403 for simplicity) can communicate with the memory devices 423 to perform operations such as reading data, writing data, or erasing data at the memory devices 423 and other such operations (e.g., in response to commands scheduled on a command bus by controller 413). The controller 403 can include hardware such as one or more integrated circuits (ICs) and/or discrete components, a buffer memory, or a combination thereof. The hardware can include digital circuitry with dedicated (i.e., hard-coded) logic to perform the operations described herein. The controller 403 can be a microcontroller, special purpose logic circuitry (e.g., a field programmable gate array (FPGA), an application specific integrated circuit (ASIC), etc.), or another suitable processor.

The controller 403 can include a processing device 407 (processor) configured to execute instructions stored in a local memory 405. In the illustrated example, the local memory 405 of the controller 403 includes an embedded memory configured to store instructions for performing various processes, operations, logic flows, and routines that control operation of the memory sub-system 401, including handling communications between the memory sub-system 401 and the host system 410.

In some embodiments, the local memory 405 can include memory registers storing memory pointers, fetched data, etc. The local memory 405 can also include read-only memory (ROM) for storing micro-code. While the example memory sub-system 401 in FIG. 12 has been illustrated as including the controller 403, in another embodiment of the present disclosure, a memory sub-system 401 does not include a controller 403, and can instead rely upon external control (e.g., provided by an external host, or by a processor or controller separate from the memory sub-system).

In general, the controller 403 can receive commands or operations from the host system 410 and can convert the commands or operations into instructions or appropriate commands to achieve the desired access to the memory devices 423. The controller 403 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 423. The controller 403 can further include host interface circuitry to communicate with the host system 410 via the physical host interface. The host interface circuitry can convert the commands received from the host system into command instructions to access the memory devices 423 as well as convert responses associated with the memory devices 423 into information for the host system 410.

The memory sub-system 401 can also include additional circuitry or components that are not illustrated. In some embodiments, the memory sub-system 401 can include a cache or buffer (e.g., DRAM) and address circuitry (e.g., a row decoder and a column decoder) that can receive an address from the controller 403 and decode the address to access the memory devices 423.

In some embodiments, the memory devices 423 include local media controllers 425 that operate in conjunction with the memory sub-system controller 403 to execute operations on one or more memory cells of the memory devices 423. An external controller (e.g., memory sub-system controller 403) can externally manage the memory device 423 (e.g., perform media management operations on the memory device 423). In some embodiments, a memory device 423 is a managed memory device, which is a raw memory device combined with a local controller (e.g., local controller 425) for media management within the same memory device package. An example of a managed memory device is a managed NAND (MNAND) device.

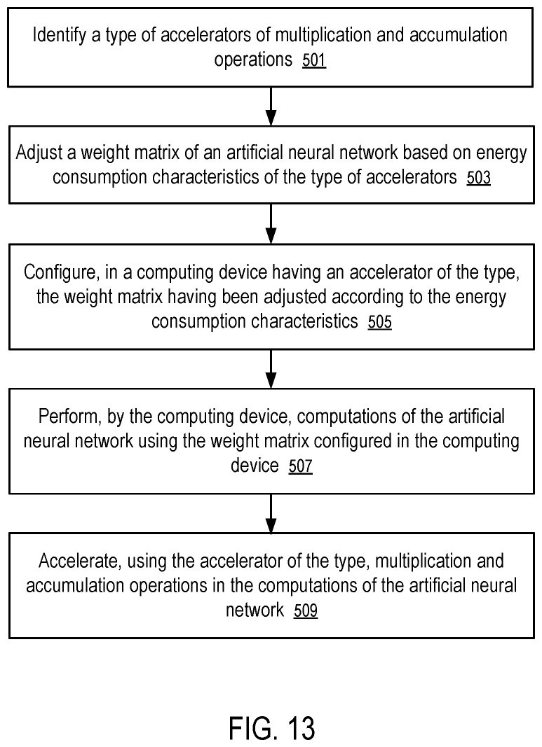

FIG. 13 shows a method to train a deep learning model according to one embodiment. For example, the method can be implemented in a computing system or device of FIG. 12. For example, the deep learning model can be trained for execution in a computing system or device of FIG. 12.

At block 501, a type of accelerators of multiplication and accumulation operations is identified. A deep learning model can be customized for the type of accelerators during training (e.g., as in FIG. 1), or through re-training (e.g., as in FIG. 2).

For example, a type (e.g., 113 or 123) of digital accelerators (e.g., 131) can be implemented using logical multiply-accumulate units 141 for multiplication (e.g., as in FIG. 9, FIG. 10, FIG. 11). As a result, such accelerators (e.g., 131) can have the characteristics 151 of consuming similar amounts of energy for different patterns of weight distributions. It is not necessary to suppress any patterns of weights to customize the weight matrix of an artificial neural network in the deep learning model.

For example, a type of photonic accelerators (e.g., 133) can be implemented using microring resonators 143 for multiplication (e.g., as in FIG. 4, FIG. 5). As a result, such accelerators (e.g., 133) can have the characteristics 153 of consuming more energy for a pattern of weight concentrating at a low magnitude region in a weight magnitude distribution than for a pattern of weights concentrating at a high magnitude region. Thus, it is preferred to use a loss function (e.g., 117) to suppress a pattern of weights concentrating at a low magnitude region in a weight magnitude distribution during machine learning 103 from a training dataset 101, or to selectively pruning weights to suppress such a pattern via re-training 104.

For example, a type of electric accelerators (e.g., 137) can be implemented using memristors 147 for multiplication. As a result, such accelerators (e.g., 137) can have the characteristics 157 of consuming more energy for a pattern of weights concentrating at a high magnitude region in a weight magnitude distribution than for a pattern of weights concentrating at a low magnitude region. Thus, it is preferred to use a loss function (e.g., 127) to suppress a pattern of weights concentrating at a high magnitude region in a weight magnitude distribution during machine learning 103 from a training dataset 101, or to selectively pruning weights to suppress such a pattern via re-training 104.

For example, a type of analog computing module (e.g., 135) can be implemented using a synapse memory cell array 145 for multiplication. As a result, such accelerators (e.g., analog computing module 135) can have the characteristics 151 of consuming more energy for a pattern of weight bit distribution more concentrated in bits having a first value (e.g., one) than bits having a second value (e.g., zero). Thus, it is preferred to use a loss function (e.g., 127) to suppress a pattern of weight bit distribution more concentrated in bits having the first value (e.g., one) during machine learning 103 from a training dataset 101, or to selectively pruning weight bits having the first value (e.g., by flipping to the second value) to suppress such a pattern via re-training 104.

At block 503, a weight matrix of an artificial neural network is adjusted based on energy consumption characteristics (e.g., 115 or 125) of the type (e.g., 113 or 123) of accelerators.

For example, the adjusting, at block 503, of the weight matrix can include the training of the weight matrix (e.g., 105 or 107) according to a training dataset 101 through machine learning 103. The training of the weight matrix (e.g., 105 or 107) can include reducing a loss function (e.g., 117 or 127) associated with the energy consumption characteristics (e.g., 115 or 125).

For example, to customize the training of the weight matrix (e.g., 105) for accelerators (e.g., 111) of the type 113 implemented using microring resonators 143 as computing elements for multiplication, the loss function 117 can be configured to penalize small weights more than large weights.

For example, to customize the training of the weight matrix (e.g., 107) for accelerators (e.g., 121) of the type 123 implemented using memristors 147 as computing elements for multiplication, the loss function 127 can be configured to penalize large weights more than small weights.

For example, to customize the training of the weight matrix (e.g., 105 or 107) for accelerators (e.g., 111 or 121) of the type (e.g., 113 or 123) implemented using a synapse memory cell array 145 as computing elements for multiplication, the loss function (e.g., 117 or 127) can be configured to penalize a first type of bits more than a second type of bits in weights in the weight matrix (e.g., 105 or 107). For example, bits of the first type have a value of one; and bits of the second type have a value of zero.

For example, the adjusting, at block 503, of the weight matrix can include the re-training of an input weight matrix 106 according to a pruning selection (e.g., 119 or 129) to suppress a pattern of weights in the input weight matrix 106.

For example, the re-training 104 can include modifying a first portion of the input weight matrix 106, and adjusting a second portion of the input weight matrix 106 to reduce differences between outputs generated using the input weight matrix 106 and outputs generated using a re-trained weight matrix (e.g., 105 or 107). The re-training 104 can further include determining an accuracy performance level of the re-trained weight matrix (e.g., 105 or 107), determining an energy performance level of the re-trained weight matrix (e.g., 105 or 107), evaluating a combined performed level based on the accuracy performance level and the energy performance level (e.g., through a weighted average), and searching for a weight selection and modification solution to improve or optimize the combined performed level of the re-trained weight matrix (e.g., 105 or 107).

For example, the adjusting, at block 503, of the weight matrix can include the training of the weight matrix (e.g., 105 or 107) according to a training dataset 101 through machine learning 103. The training of the weight matrix (e.g., 105 or 107) can include reducing a loss function (e.g., 117 or 127) associated with the energy consumption characteristics (e.g., 115 or 125).

For example, to customize the training of the weight matrix (e.g., 105) for accelerators (e.g., 111) of the type 113 implemented using microring resonators 143 as computing elements for multiplication, the pruning selection 119 can be configured to select small weights from the weight matrix 106 and increase the selected small weights.

For example, to customize the training of the weight matrix (e.g., 107) for accelerators (e.g., 121) of the type 123 implemented using memristors 147 as computing elements for multiplication, the pruning selection 129 can be configured to select large weights from the weight matrix 106 and reduce the selected large weights.

For example, to customize the training of the weight matrix (e.g., 105 or 107) for accelerators (e.g., 111 or 121) of the type (e.g., 113 or 123) implemented using a synapse memory cell array 145 as computing elements for multiplication, the pruning selection (e.g., 119 or 129) can be configured to select a first type of bits for conversion to a second type of bits in weights in the weight matrix (e.g., 105 or 107). For example, bits of the first type have a value of one; and bits of the second type have a value of zero.

At block 505, the weight matrix (e.g., 105 or 107) having been adjusted according to the energy consumption characteristics is configured in a computing device (e.g., as in FIG. 12) having an accelerator (e.g., 100) of the type (e.g., 113 or 123).

Through the training of FIG. 1 or re-training 104 of FIG. 2, the weight matrix (e.g., 105 or 107) can have a weight pattern that is energy efficient for the accelerator (e.g., 100) to operate upon.

For example, when the accelerator (e.g., 100) is a photonic accelerator 133 having microring resonators 143 as computing elements for multiplication, the weight matrix (e.g., 105) configured in the computing device (e.g., as in FIG. 12) has the pattern of weights with a weight distribution that is more concentrated in a first magnitude region than a second magnitude region lower than the first magnitude region.

For example, when the accelerator (e.g., 100) is an electric accelerator having memristors 147 as computing elements for multiplication, the weight matrix (e.g., 105) configured in the computing device (e.g., as in FIG. 12) has the pattern of weights with a weight distribution more concentrated in a first magnitude region than a second magnitude region higher than the first magnitude region.

For example, when the accelerator (e.g., 100) is an analog computing module 135 having a synapse memory cell array 145 as computing elements for multiplication, the weight matrix (e.g., 105) configured in the computing device (e.g., as in FIG. 12) has the pattern of weights with a weight bit distribution more concentrated in bits having a first value (e.g., zero) than bits having a second value (e.g., one).

At block 507, the computing device (e.g., as in FIG. 2) performs computations of the artificial neural network using the weight matrix (e.g., 105 or 107) configured in the computing device.

At block 509, the accelerator (e.g., 100) of the type (e.g., 113 or 123) accelerates multiplication and accumulation operations in the computations of the artificial neural network.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
identifying a type of accelerators of multiplication and accumulation operations;
adjusting a weight matrix of an artificial neural network based on energy consumption characteristics of the type of accelerators;
configuring, in a computing device having an accelerator of the type, the weight matrix having been adjusted according to the energy consumption characteristics; and
accelerating, using the accelerator of the type, multiplication and accumulation operations in computations of the artificial neural network performed using the weight matrix configured in the computing device.

2. The method of claim 1, wherein the adjusting of the weight matrix includes training of the weight matrix according to a training dataset.

3. The method of claim 2, wherein the training of the weight matrix includes reducing a loss function associated with the energy consumption characteristics.

4. The method of claim 3, wherein accelerators of the type are implemented using microring resonators as computing elements for multiplication; and the loss function is configured to penalize small weights more than large weights.

5. The method of claim 3, wherein accelerators of the type are implemented using memristors as computing elements for multiplication; and the loss function is configured to penalize large weights more than small weights.

6. The method of claim 3, wherein accelerators of the type are implemented using synapse memory cells as computing elements for multiplication; and the loss function is configured to penalize a first type of bits more than a second type of bits in weights.

7. The method of claim 6, wherein bits of the first type have a value of one; and bits of the second type have a value of zero.

8. The method of claim 1, wherein the adjusting of the weight matrix includes re-training an input weight matrix according to a pruning selection to suppress a pattern of weights in the input weight matrix.

9. The method of claim 8, wherein the re-training includes modifying a first portion of the input weight matrix and adjusting a second portion of the input weight matrix to reduce differences between outputs generated using the input weight matrix and outputs generated using a re-trained weight matrix.

10. The method of claim 9, wherein the re-training further includes determining an accuracy performance level of the re-trained weight matrix, determining an energy performance level of the re-trained weight matrix, evaluating a combined performed level based on the accuracy performance level and the energy performance level, and searching for a weight selection and modification solution to improve or optimize the combined performed level.

11. A computing device, comprising:
an accelerator having an energy consumption characteristics in performance of multiplication and accumulation operations;
a memory device configured with a weight matrix customized according to the energy consumption characteristics; and
a processing device configured to implement computations of an artificial neural network using the weight matrix and the accelerator.

12. The computing device of claim 11, wherein the weight matrix is trained to have a pattern of weights that reduces energy expenditure of the accelerator in performing multiplication and accumulation operations on the weight matrix.

13. The computing device of claim 12, wherein the accelerator includes microring resonators as computing elements for multiplication; and the pattern of weights has a weight distribution more concentrated in a first magnitude region than a second magnitude region lower than the first magnitude region.

14. The computing device of claim 12, wherein the accelerator includes memristors as computing elements for multiplication; and the pattern of weights has a weight distribution more concentrated in a first magnitude region than a second magnitude region higher than the first magnitude region.

15. The computing device of claim 12, wherein the accelerator includes synapse memory cells as computing elements for multiplication; and the pattern of weights has a weight bit distribution more concentrated in bits having a first value than bits having a second value.

16. A non-transitory computer storage medium storing instructions which, when executed in a computing system, cause the computing system to perform a method, comprising:
receiving a first weight matrix;
selecting a first portion of weights in the first weight matrix according to an energy consumption characteristics of an accelerator of multiplication and accumulation operations;
modifying the first portion of the weights in the first weight matrix;
re-training a second portion of the weights in the first weight matrix to generate a second weight matrix; and
providing the second weight matrix for acceleration by the accelerator in computations of an artificial neural network configured according to the second weight matrix.

17. The non-transitory computer storage medium of claim 16, wherein the method further comprises:
determining an accuracy performance level of the second weight matrix;
determining an energy performance level of the second weight matrix;
evaluating a combined performed level based on the accuracy performance level and the energy performance level; and
searching for a solution to select the first portion and modify the first portion to improve or optimize the combined performed level.

18. The non-transitory computer storage medium of claim 17, wherein the accelerator includes microring resonators as computing elements for multiplication; and the first portion is selected to include weights of small magnitudes in a weight distribution of the first weight matrix.

19. The non-transitory computer storage medium of claim 17, wherein the accelerator includes memristors as computing elements for multiplication; and the first portion is selected to include weights of large magnitudes in a weight distribution of the first weight matrix.

20. The non-transitory computer storage medium of claim 17, wherein the accelerator includes synapse memory cells as computing elements for multiplication; and the first portion is selected to include weight bits having a value of one.
